(19) United States
(12) Patent Application Publication
(10) Pub. No.: US 2009/0321158 A1
(43) Pub. Date: Dec. 31, 2009

(54) Hybrid Vehicle Having a Split Engine

(75) Inventors: Hans Glonner, Pfaffenhofen (DE); Gert Fischer, Feldafing (DE); Raymond Freymann, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 12/552,819

(22) Filed: Sep. 2, 2009

Related U.S. Application Data
(63) Continuation of application No. PCT/EP2008/001071, filed on Feb. 13, 2008.

(30) Foreign Application Priority Data
Mar. 3, 2007 (DE) 10 2007 010 343.5

(51) Int. Cl. B60K 6/442

(52) U.S. Cl. 180/65.23; 180/65.21

(57) ABSTRACT

A hybrid vehicle includes an internal-combustion engine drive coupleable with a transmission by way of a first coupling device, and an electric machine. A transmission is drivable exclusively by the internal-combustion engine drive, or simultaneously by the internal-combustion engine drive and by the electric machine, or when the first coupling device is open, exclusively by the electric machine. The internal-combustion engine drive has a first internal-combustion engine unit, which can be coupled with the transmission by way of the first coupling device, and a second internal-combustion engine unit, which can be coupled with the first internal-combustion engine unit by way of a second coupling device.

### CROSS-REFERENCE TO RELATED APPLICATIONS

This application is a continuation of PCT International Application No. PCT/EP2008/001071, filed Feb. 13, 2008, which claims priority under 35 U.S.C. § 119 to German Patent Application No. DE 10 2007 010 343.5, filed Mar. 3, 2007, the entire disclosures of which are herein expressly incorporated by reference.

### BACKGROUND AND SUMMARY OF THE INVENTION

The present invention relates to a hybrid vehicle having an internal-combustion engine drive, which can be coupled with a transmission by way of a first coupling device, and an electric machine. The transmission is drivable (i) exclusively by the internal-combustion engine drive unit, (ii) simultaneously by the internal-combustion engine drive unit and by the electric machine, or (iii) when the first coupling device is open, exclusively by the electric machine.

As used herein, the term “hybrid vehicle” applies to a vehicle having an internal-combustion engine drive and at least one electric machine, which is provided for recuperating braking energy in a generating manner and for supporting the internal-combustion engine drive by way of an electric motor in some operating conditions, or for driving the vehicle purely by use of the electric motor in other operating conditions.

It is an object of the invention to develop a hybrid vehicle whose available power potential is adapted as well as possible to the momentary power demand.

This object is achieved by providing a hybrid vehicle having an internal-combustion engine drive, which can be coupled with a transmission by way of a first coupling device, and an electric machine. The transmission is drivable (i) exclusively by the internal-combustion engine drive, (ii) simultaneously by the internal-combustion engine drive and by the electric machine, or (iii) when the first coupling device is open, exclusively by the electric machine. The internal-combustion engine drive has a first internal-combustion engine unit, which can be coupled with the transmission by way of the first coupling device, and a second internal-combustion engine unit, which can be coupled with the first internal-combustion engine unit by way of a second coupling device. Advantageous embodiments and further developments of the invention are described herein.

The starting point of the invention is a hybrid vehicle having an internal-combustion engine drive, which can be coupled with a transmission by way of a first coupling device, and having an electric machine, the transmission optionally being drivable (i) exclusively by the internal-combustion engine drive, (ii) simultaneously by the internal-combustion engine drive and by the electric machine, or (iii) when the first coupling device is open, exclusively by the electric machine.

An aspect of the invention consists of the fact that the internal-combustion engine drive has at least two internal-combustion engine units, specifically a first internal-combustion engine unit, which can be coupled with the transmission by way of the first coupling device, and a second internal-combustion engine unit, which can be coupled with the first internal-combustion engine unit by way of a second coupling device.

In the operating conditions in which there is only an average power demand, the vehicle can be driven exclusively by the first internal-combustion engine unit and/or by the electric machine. When higher power is required, for example, during high-speed driving on a turnpike, the second internal-combustion engine unit can be connected.

The two internal-combustion engine units may, for example, each be an “internal-combustion engine” with two cylinders. However, the number of cylinders of each individual internal-combustion engine unit does not have to be identical but may also be different.

Being operated in a large number of operating conditions, such a hybrid vehicle may take up the following operating conditions, for example:
(a) Operating condition 1, in which both internal-combustion engine units are switched off and the hybrid vehicle is driven exclusively by the electric machine.
(b) Operating condition 2, in which the first internal-combustion engine unit is switched on and the second internal-combustion engine unit is switched off. In this operating condition, the vehicle can then be driven exclusively by the first internal-combustion engine and by the electric machine if the latter is connected.
(c) Operating condition 3, in which both internal-combustion engine units are switched on. In this operating condition, the vehicle can then be driven by the entire power provided by the internal-combustion engine; i.e. by both internal-combustion engine units, and by the electric machine if the latter is connected.

A corresponding electronic system is provided for controlling the electric machine. According to a further development of the invention, it is provided that, during the transition from operating condition 2 to operating condition 3, i.e., when the second internal-combustion engine unit is started, the electric machine generates a drive torque at least for a short time, which supports the start of the second internal-combustion engine unit. During the starting of the second internal-combustion engine unit, the electric machine preferably supplies at least so much torque generated by the electric motor that the power required for the starting operation is compensated and a (temporary) drop in torque at the transmission input is avoided.

According to a further development of the invention, the electric machine can, also in a coasting operation, by use of a generating load moment, compensate the deceleration behavior during the coupling and uncoupling of the second internal-combustion engine unit.

In particular, the electric machine can also be used as a starter for the first internal-combustion engine unit.

Other objects, advantages and novel features of the present invention will become apparent from the following detailed description of one or more preferred embodiments when considered in conjunction with the accompanying drawings.

### BRIEF DESCRIPTION OF THE DRAWING

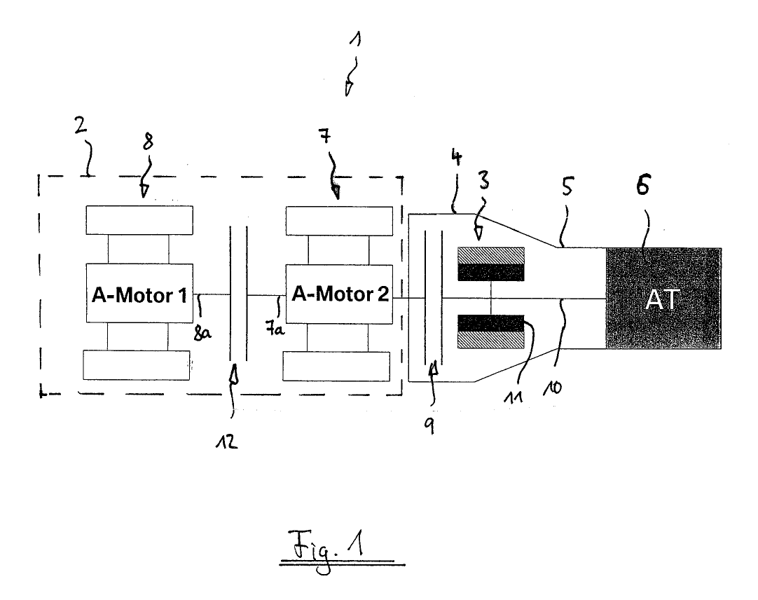

The single FIG. 1 is a schematic view of the basic principle of the invention.

### DETAILED DESCRIPTION OF THE DRAWING

FIG. 1 illustrates a transmission line 1 of a hybrid vehicle which has an internal-combustion engine drive 2 and an electric machine 3 which, in this case, is arranged inside the bell-shaped part 4 of a transmission case 5 of a transmission 6.

The internal-combustion engine drive 2 is formed by a first internal-combustion engine unit 7 and a second internal-combustion engine unit 8, which may both be accommodated in a common engine power section. The two internal-combustion engine units 7, 8 each have a separate crankshaft 7a, 8a. The two internal-combustion engine units 7, 8 may be units with the same number of cylinders or with a different number of cylinders. The internal-combustion engine unit 7 and the internal-combustion engine unit 8 may each, for example, by a “two-cylinder engine”.

As illustrated in FIG. 1, the internal-combustion engine unit 7 is connected by way of a first coupling 9 with an input shaft 10 of the transmission 6. A rotor 11 of the electric machine 3 is non-rotatably connected with the input shaft 10 of the transmission 6. When the coupling 9 is closed, the transmission 6 can therefore be driven by the first internal-combustion engine unit 7 and by the electric machine 3, if the latter is connected.

During braking operations, the electric machine 3 can be used for the recuperation of braking energy, i.e., for converting mechanical energy to electric energy. In this operating condition, the electric machine operates as a generator driven by the transmission input shaft 10.

In addition, the electric machine 3 can be used as a starter for the first internal-combustion engine unit 7. Fed by an energy accumulator, for example, a battery or a capacitor, not shown here in detail, the first internal-combustion engine unit 7 can be started by the electric machine 3 when the coupling 9 is closed.

A second coupling 12 is arranged between the two crankshafts 7a, 8a of the two internal-combustion engine units 7, 8. When the two couplings 9, 12 are closed, the transmission can be driven by both internal-combustion engine units 7, 8 simultaneously and by the electric machine 3, if the latter is also connected.

In order to avoid a drop in torque and thus a drop in speed or acceleration of the vehicle when starting the second internal-combustion engine unit 8, the starting torque for the second internal-combustion engine unit 8 can be compensated by the electric machine 3 as the start progresses.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A hybrid vehicle, comprising:
an internal-combustion engine drive;
an electric machine;
a transmission, wherein the internal-combustion engine drive is coupleable with the transmission via a first coupling device;
wherein the transmission is drivable (i) exclusively by the internal-combustion engine drive, (ii) simultaneously by the internal-combustion engine drive and by the electric machine, or (iii) exclusively by the electric machine when the first coupling device is open; and
wherein the internal-combustion engine drive comprises a first internal-combustion engine unit, which is coupleable with the transmission by way of the first coupling device, and a second internal-combustion engine unit, which is coupleable with the first internal-combustion engine unit via a second coupling device.

2. The hybrid vehicle according to claim 1, wherein during operation of the hybrid vehicle, the internal-combustion engine drive is operably configurable such that:
in a first operating condition, the first and second internal-combustion engine units are switched-off or uncoupled and the hybrid vehicle is driven exclusively by the electric machine;
in a second operating condition, the first internal-combustion engine unit is switched-on and the second internal-combustion engine unit is switched-off or uncoupled; and
in a third operating condition, the first and second internal-combustion engine units are switched-on or coupled together.

3. The hybrid vehicle according to claim 1, further comprising an electric control unit operably configured to control the electric machine.

4. The hybrid vehicle according to claim 2, further comprising an electric control unit operably configured to control the electric machine.

5. The hybrid vehicle according to claim 2, wherein during a transition from the second operating condition to the third operating condition, the electric machine generates a drive torque that supports a start of the second internal-combustion engine unit and substantially prevents a drop in torque at an input of the transmission.

6. The hybrid vehicle according to claim 3, wherein during a transition from the second operating condition to the third operating condition, the electric machine generates a drive torque that supports a start of the second internal-combustion engine unit and substantially prevents a drop in torque at an input of the transmission.

7. The hybrid vehicle according to claim 4, wherein during a transition from the second operating condition to the third operating condition, the electric machine generates a drive torque that supports a start of the second internal-combustion engine unit and substantially prevents a drop in torque at an input of the transmission.

8. The hybrid vehicle according to claim 1, wherein the electric machine comprises a rotor non-rotatably connected with an input shaft of the transmission.

9. The hybrid vehicle according to claim 2, wherein the electric machine comprises a rotor non-rotatably connected with an input shaft of the transmission.

10. The hybrid vehicle according to claim 3, wherein the electric machine comprises a rotor non-rotatably connected with an input shaft of the transmission.

11. The hybrid vehicle according to claim 5, wherein the electric machine comprises a rotor non-rotatably connected with an input shaft of the transmission.

12. The hybrid vehicle according to claim 1, wherein the first coupling device is operably arranged between the first internal-combustion engine unit and the transmission.

13. The hybrid vehicle according to claim 2, wherein the first coupling device is operably arranged between the first internal-combustion engine unit and the transmission.

14. The hybrid vehicle according to claim 1, wherein the second coupling device is operably arranged between the first and second internal-combustion engine units and, in a closed condition, couples a crankshaft of the first internal-combustion engine unit with a crankshaft of the second internal-combustion engine unit.

15. The hybrid vehicle according to claim 2, wherein the second coupling device is operably arranged between the first and second internal-combustion engine units and, in a closed condition, couples a crankshaft of the first internal-combustion engine unit with a crankshaft of the second internal-combustion engine unit.

16. The hybrid vehicle according to claim 5, wherein the second coupling device is operably arranged between the first and second internal-combustion engine units and, in a closed condition, couples a crankshaft of the first internal-combustion engine unit with a crankshaft of the second internal-combustion engine unit.

17. The hybrid vehicle according to claim 12, wherein the second coupling device is operably arranged between the first and second internal-combustion engine units and, in a closed condition, couples a crankshaft of the first internal-combustion engine unit with a crankshaft of the second internal-combustion engine unit.

18. A method of operating a hybrid vehicle having an internal-combustion engine drive coupleable with a transmission via a first coupling device, and an electric machine, the method comprising the acts of:
operating the hybrid vehicle in a first operating condition in which first and second internal-combustion engine units of the internal-combustion engine drive are uncoupled from the transmission and the hybrid vehicle is driven exclusively by the electric machine;
operating the hybrid vehicle in a second operating condition in which the first internal-combustion engine unit is coupled to the transmission and the second internal-combustion engine unit is uncoupled from the transmission; and
operating the hybrid vehicle in a third operating condition in which the first and second internal-combustion engine units are coupled to the transmission.

19. The method according to claim 18, wherein when transitioning from the second operating condition to the third operating condition, the method further comprises the act of generating a drive torque via the electric machine, the generated drive torque being sufficient to support a start of the first internal-combustion engine unit and to substantially prevent a drop in torque at an input of the transmission.
